(19) United States
(12) Patent Application Publication
(10) Pub. No.: US 2025/0316181 A1
(43) Pub. Date: Oct. 9, 2025

(54) METHOD TO CONTROL NATURAL NON-PLAYER CHARACTER RESPONSES FOR JUDGMENTAL USE-OF-FORCE SIMULATION TRAINING

(71) Applicant: InVeris Training Solutions, Inc., Suwanee, GA (US)

(72) Inventors: Anthony Liparulo, Suwanee, GA (US); James Marion Napier, Buford, GA (US); Ajit Venugopal, Alpharetta, GA (US)

(21) Appl. No.: 19/096,508

(22) Filed: Mar. 31, 2025

Related U.S. Application Data
(60) Provisional application No. 63/572,011, filed on Mar. 29, 2024.

(51) Int. Cl. G09B 9/00

(52) U.S. Cl. CPC G09B 9/00

(57) ABSTRACT

Systems and methods for controlling characters in a judgmental use of force training simulation are provided. The systems and methods use a compliance range with endpoints that represent all possible responses from maximum non-compliance to maximum compliance and the various levels of compliance between the endpoints. For characters in the simulation, the systems and methods select an appropriate response by comparing a single compliance value assigned to the character from the compliance range with the single compliance value from the compliance range assigned to a responsive macro in a pool of responsive macros.

### FIELD

The present patent document relates to judgmental/de-escalation training. In particular, the present patent document relates to methods to control character responses for judgmental use-of-force simulation training.

### BACKGROUND

Instructors conducting de-escalation training systems have a need to control the level of compliance in a scenario during the training, which they currently achieve by activating a set of generic user interface controls that control the actions of the Non-Playing Characters (NPCs).

Judgmental use-of-force, a.k.a. de-escalation, simulation trainers have been around for decades. In nearly all instances, one or more trainees is presented a scenario where they must quickly evaluate the situation being presented and use their judgment to attempt to de-escalate the situation in a manner that limits potential harm. The simulation trainers typically use either videos or computer graphics imagery to present the trainee(s) with scenarios such as traffic stops, domestic violence situations, hostage situations or emotionally disturbed persons, to name a few. One goal of this type of training is to familiarize the trainee(s) with these situations such that they avoid using lethal force unless absolutely necessary.

Traditionally, the instructor/operator is constantly evaluating the trainee's actions and then trying to “guide” the scenario in a manner that either escalates or de-escalates the situation to help the trainee better understand how they might better use their demeanor, body language, verbal responses, and lethal and less lethal weapons to achieve the best outcome possible. The methods they use to “guide” the scenario are by choosing actions (or video “branches”) of alternative responses. As just one example of a scenario that the instructor may choose would be when the bad actor has a weapon, but the trainee successfully talks in such a way that the instructor chooses to branch to a video snippet of the character dropping their weapon instead of shooting.

Steering the training towards a particular scenario may be accomplished using video branches for older-style video scenarios or in computer graphic simulations, may be accomplished by choosing actions for the non-player characters (“NPC”) to perform like: drop weapon, step back, raise hands in surrender or yell threateningly.

Regardless of whether the system uses video branches or computer graphics, in both methods, the instructor/operator is left with the challenging task of choosing these responses in a timely manner, otherwise the trainee will notice an unnatural delay in a believable response. This often leads to an instructor trying to desperately “keep up” with choosing successive responses as the trainee continues to respond to the situation, making it very difficult for the instructors to achieve the desired training objectives.

The current methods require the instructor/operator to manually control the actions by the NPCs in an attempt to make the response believable and appropriate based on the trainee's actions. Accordingly, the time it takes the instructor to decide the response and then find and activate the right controls to achieve realism often introduces delay in the NPC's response, thus breaking the illusion of realism and trainee immersion desired. This reduces the effectiveness of the training. What is needed is a means to escalate or de-escalate the response of the characters and thus the overall situation in a way that is context appropriate and also fast enough to maintain the suspension of disbelief of a training exercise.

### SUMMARY OF THE EMBODIMENTS

A simplified means to control the compliance level of a judgmental/de-Escalation training scenario is provided. The software manifests the requested compliance level to the trainees, through realistic responses such as emotional expressions, physical actions, verbalizations, and any such reaction to the general context created due to the actions of the participating trainees in the scenario in keeping with the compliance level selected by the instructor/operator for each character or subset of characters in the simulation.

Systems and methods for controlling characters in a judgmental use of force training simulation is provided. In preferred embodiments, the system comprises a compliance range. The compliance range is designed to represent the varying levels of compliance a character can have. The compliance range has a first endpoint that corresponds to maximum compliance and an opposite endpoint that corresponds to maximum non-compliance. All the values between the first endpoint and opposite endpoint correspond to varying levels of compliance between maximum compliance and maximum non-compliance.

The system comprises a plurality of characters wherein each character in the plurality of characters is assigned a first single compliance value from the compliance range;

The system further comprises a plurality of pools of macros wherein each pool of macros in the plurality of pools corresponds to a particular character response and wherein each macro in any pool of macros from the plurality of pools of macros is assigned a second single compliance value from the compliance range.

In operation, the system is designed to select a macro with the closest second single compliance value to the first single compliance value when selecting an appropriate action response for a character from the plurality of characters.

In preferred embodiments, the compliance range has a median that represents a neutral response and responses become progressively more non-compliant on one side of the median and progressively more compliant on an opposite side of the median. The degree to which the responses vary from neutral as the compliance value departs from the median is typically linear however, other gradients may be uses such as asymptotic.

In preferred embodiments, the first single compliance value for each character or groups of characters is selectable prior to commencement of the simulation and adjustable thereafter.

In some embodiments, the system comprises a system wide compliance value that can control the first single compliance value for each character in the plurality of characters.

In some embodiments, the first single compliance value of each character is designed to adjust automatically based on a response of a trainee.

In some embodiments, subsets of characters from the plurality of characters are grouped into teams and the first single compliance value of each character in a team is designed to be set by a single team compliance value.

In preferred embodiments, each macro is comprised of a plurality of character actions. Each character action is assigned a third compliance value from the compliance range. The second compliance value for each macro is comprised from the combination of each third compliance value of each character action in each macro.

In preferred embodiments, each character's facial expression is adjusted based on the first compliance value.

In another aspect of the embodiments described herein, a method for controlling characters in a judgmental use of force training simulation is provided. In preferred embodiments, the method comprises assigning a first compliance value to each character in the simulation wherein the first compliance value is selected from a compliance range having a first endpoint that corresponds to maximum compliance and an opposite endpoint that corresponds to maximum non-compliance. The values between the first endpoint and opposite endpoint corresponding to varying levels of compliance between maximum compliance and maximum non-compliance.

The method is activated by receiving a request for an action for a first character in the simulation. The method selects a pool of macros that corresponds with an appropriate response to the request for an action. The method selects a macro from the pool of macros with the with closest second single compliance value to the first single compliance value wherein each macro in the pool of macros is assigned a second single compliance value from the compliance range.

Once the appropriate macro is selected, the method executes the macro to cause the first character to respond to the request for action.

### BRIEF DESCRIPTION OF THE DRAWINGS

FIG. 1 illustrates a macro with a compliance value comprised from the plurality of compliance values associated with individual actions contained within the macro.; and

FIG. 2 illustrates a flowchart of a method to control natural non-player character responses for judgmental use-of-force simulation training.

### DETAILED DESCRIPTION OF THE DRAWINGS

One objective of the invention is to drive natural believable responses of the NPCs using a simplified “compliance” value that once set, allows the system to perform believable, context-appropriate, responses of the characters.

When a trainee is involved in a simulation scenario, the characters in that simulation scenario can take actions that will escalate the situation or actions that would de-escalate the situation. A non-compliant response by a character is a response that would typically lead to an escalation of the situation or threat and a compliant response by a character is a reaction that would typically lead to de-escalation of the situation or theat. A neutral response is a character response that neither escalates or de-escalates the situation.

As may be appreciated, there are actions a character can take that may escalate or de-escalate the situation only slightly and actions that have rapid escalation or de-escalation. As just one example, having a character take a step forward may escalate the situation slightly while taking a step back may de-escalate the situation slightly. In contrast, having the character draw a weapon is a massive escalation.

The inventions herein seek to allow an instructor to control the responses of the computer-controlled character(s) in a more efficient way to create a more believable response without delay but while still allowing the instructor to control the escalation or de-escalation of the simulation in real time. To these ends, in preferred embodiments, a character's compliance is a single value from within a compliance range, stored per-character, that acts as a driver in decision making related to automatic actions for said character to invoke. For example, in preferred embodiments, each character may have a compliance value from minus one (−1) to one (1) where less than zero (<0) is non-compliant and greater than zero (>0) is compliant. Within the range of compliance values, the median value is typically treated as neutral. In the range of minus one to one, values near zero will be treated as neutral and in some cases could allow the character to pick a compliant or non-compliant response.

In preferred embodiments, the compliance value is set by the instructor during authoring when setting up the scenario and placing characters. Accordingly, the instructor sets the initial compliance value of the various characters that will appear in a simulation scenario prior to the scenario beginning. Although each character has an initial compliance value, the compliance value may be altered during scenario runtime. The instructor may alter the compliance value in the way they want a particular character to gravitate towards.

For example, the compliance level may be set to highly non-compliant and the character may choose to remain combative as the trainee attempts to talk to them politely, eventually resulting in an overt threat that would require the trainee to take more decisive actions.

As taught herein, the compliance level is a single value within a compliance range set by the instructor at any time. A character's compliance level may be adjusted by the instructor at any time, based on how the trainee performs. The ability to have the character's compliance level controlled by a single value allows the characters to behave in a consistent way, as desired by the instructor, without requiring the instructor to make multiple selections at precise times.

The single value assigned to each character in the scenario is used by the software to automatically select natural responses for each NPC in the scenario based on that character's role and unique objectives. As the trainee responds to the scenario, the instructor/operator can 1) allow the scenario to play out in a believable manner based on the currently selected level of compliance, 2) adjust the level of compliance for either greater or less compliance to account for the trainee's actions accordingly, or 3) potentially choose context-appropriate specific actions that are based on the level of compliance chosen and the trainee's responses.

In preferred embodiments, the instructor can adjust a single high-level value that will control the compliance of all the characters in the scenario or can adjust the single value assigned to each character such that individual characters act with different compliance levels within the scenario. The characters will continue to respond based on their assigned compliance level value until it is changed.

The compliance value assigned to a character controls how the character responds. When a character receives input such as an aggressive action towards them, for example a trainee pulls a weapon or a request is made in their direction, a request is triggered for the character to automatically run an action in response. The decision for which pool to pull an action from is based on scenario context and action type (I.E. Respond To Officer, or React To Handcuff), then the specific action/macro in that pool is based on compliance level. Higher compliance is related to more submissive and passive actions while lower compliance leads to aggressive and unruly actions from the character.

### Automatic Adjustment

In preferred embodiments, compliance may also be automatically adjusted based on actions and behaviors of the active trainee(s). If a trainee is loud or yells aggressive commands, then a character's compliance can start to drop towards non-compliant/aggression or vice versa. In preferred embodiments, the system is calibrated to the trainee prior to beginning a scenario and then the system may adjust automatically thereafter.

The change of compliance automatically during scenario runtime also acts as a sort of “grading system” for use-of-force and judgmental training. Where the delta of compliance level from scenario start to scenario end is the grade. For example, if a suspect starts a scenario with a −0.25 compliance level and through trainee actions such as speaking clearly, not drawing a lethal weapon unprompted, and remaining at a distance the suspect's compliance level ends up being 0.15 by scenario end, then the improvement is 0.4.

### Multiple Suspects

Characters in the training platform can be set into “teams”. This is done during the authoring stage of the application. These “teams” differ suspects from bystanders, but also allows for different or competing groups of suspects, like gangs. During scenario runtime, the instructor has the option to select an entire team, and adjust the compliance level of all characters on said team overwriting their current value.

### Macros

To add complex behaviors backing the compliant value, the preferred embodiments implement a macro structure for the character actions.

A character action is the most basic block of a “command” that a character can do. It is a single action that can be committed to. Examples of character actions include but are not limited to: step forward; walk here; right hand in air; reach towards pocket; look at “x”; play facial animation; and lift right leg. An unlimited number of other character actions may be programmed.

However, most of these actions do very little by themselves, thus macros are used to string together multiple character actions. Macros form a group of actions that run in a single sequence. A few actions were developed specifically for macros such as waiting and wait for so that actions in a macro can have delayed actions or even conditional actions.

Macros create larger behaviors such as attack target, drop weapon, get on the ground, and find cover.

When a Character is told, by a separate input, to automatically react with their own action/behavior, they use their compliant level to pick a macro out of a related pool. For example, if a trainee pulls out a lethal weapon and aims at a character—the system tells the character to invoke a “Down Range Reaction”, which specifies what pool of macros to pull from. Then the character, using their current compliance level, grabs a macro from said pool and runs it.

To this end, a system is created where characters are assigned a single compliance level and based on a scenario, respond by selecting a macro from a pool of macros. The selection of which macro to select from the pool is guided by the compliance level value.

### Compliant-Tuned Macros

In order to allow the compliance level to select an appropriate macro from a pool of macros, preferred embodiments assign a compliance level to each macro. In preferred embodiments, when a character needs a macro from a pool, the system selects the macro with a compliance value that is closest to the characters own compliance level.

In some embodiments, macros may generate their own compliance level based on the actions that populate the macro itself. For example, each individual character action may be assigned a compliance alteration value. Most character actions have a value of zero because that action alone does not alter or influence compliance—such as walking to a location. However, other character actions may have a value of greater than zero or less than zero, which represents whether the action is more a non-compliant/aggressive action or compliant/submissive action. An action like “pull out gun” has a value of negative one (−1) whereas “step backward” has a value of −0.15. The aggregate of all the actions in a macro can create or be used to modify that macro's compliance score. The compliance score of any particular macro is bounded by the overall range of the compliance value, for example in this embodiment, clamped between negative one (−1) and positive one (1).

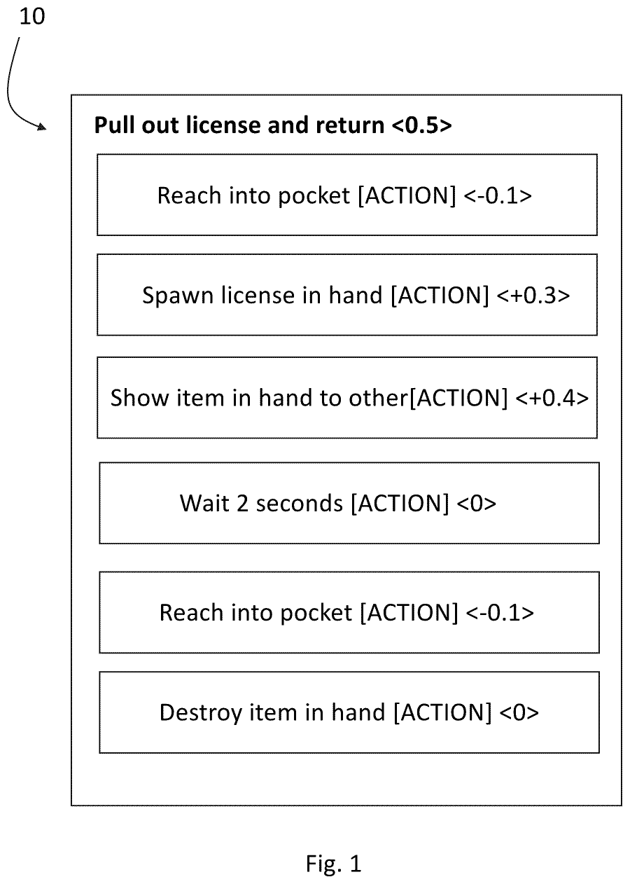

FIG. 1 illustrates a macro with a compliance value comprised from the plurality of compliance values associated with individual actions contained within the macro. The macro 10 Pull Out License and Return, scores a 0.5, which is between neutral and compliant. The macro 10 does this even though some individual actions within the macro have negative values, like Reach Into Pocket. However, the set of actions as a whole, is a compliant macro.

The compliance value of a macros doesn't always have to be the sum of their internal actions. In some embodiments, a macro's compliance value may be adjusted to better reflect the macro's effect of escalation or de-escalation regardless of the sum of the compliance values of the internal character actions.

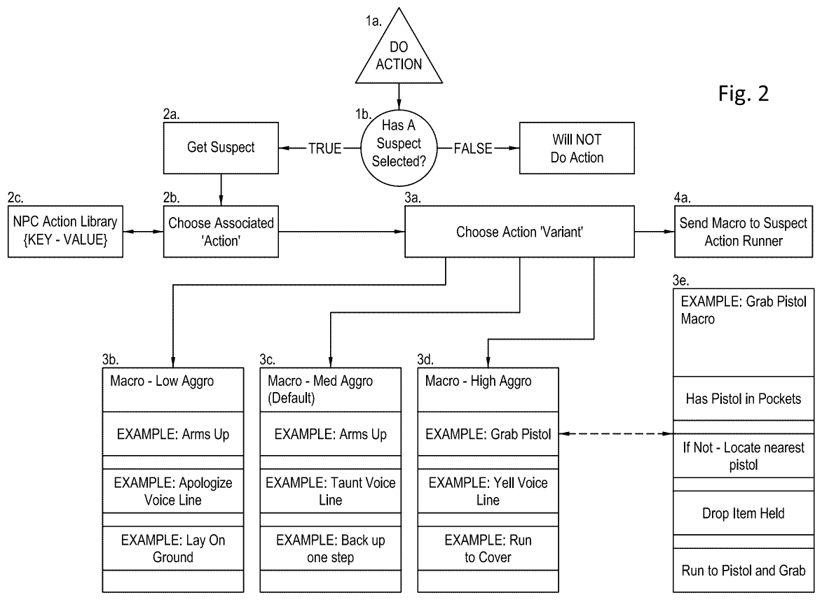

FIG. 2 illustrates a flowchart of a method to control natural non-player character responses for judgmental use-of-force simulation training. At element la, a system or ‘User’ invokes a request for an action by one of the characters in the simulation. This can be done via an automated reaction (aimed at by a lethal weapon) or by instructor explicit commands.

At element 1b, the system confirms there is an appropriate suspect/character. This is either the character that triggered the reaction by the trainee or the character selected when a command was given.

At element 2a, the character information is fetched and so is any relevant data. Various different types of data may be associated with each character. In preferred embodiments, the character data comprises: the character's compliance value, possible weapons, location of weapons such as in pockets, and current behavior and/or actions.

At element 2b/2c, before considering the character's environmental and configurable details, the system fetches a desired action from an action library. In the preferred embodiment, this same action is fetched no matter the other, more detailed, information and only looks at the original action request.

At element 3a, the system uses the contextual data, such as suspect's compliance, to pick a variant of the refenced action to run from a plurality of variants. Within the referenced action received from the action library are its “variants”. The plurality of variants may include a range from different orders of simple events to entirely different behaviors.

At element 3b/3c/3d, examples of possible action variations based off suspect's compliance. These are “macros”, which contain simple behaviors in a specific sequence with transitions between each.

At element 3e, the flowchart illustrates that any number of action variations and their macros can further nest even more macros. This enables the system to have a massive range of simple to highly complex behavior based on a single trigger and a single character compliance value.

The compliance level controller avoids the burden on the instructor to activate specific actions or response steps, by providing the control to set the “compliance level” of the NPC(s). The compliance level controller, allows the instructor to increase or decrease the challenge on the trainees proactively rather than in reaction to the trainee's actions. The compliance level controller taught herein, allows autonomous NPC behavior that is realistic because it is context sensitive and avoids instructor reaction time often delayed due to a more complicated user interface. The compliance level controller taught herein allows natural reactions in response to trainee actions. The compliance level controller taught herein allows comparison and evaluation of trainee performance in de-escalation based on the “compliance level” graph that the system calculates in autonomous mode. The compliance level controller taught herein allows comparison and evaluation of instructor performance based on instructor's “compliance level” settings against standard trainee actions.

### Speech-To-Text Processing

As described above, the system begins selecting a response for a character when a response request is triggered. One way for a response to be triggered is by the commands being issued by a trainee. The spoken words of the trainee can act as both a trigger for a response as well as influence the automatic compliance changing. In preferred embodiments, speech-to-text processing is used to convert the spoken words of the trainee into triggers or other commands the system can act on.

The speech-to-text may be located on a server and listen in on all networked audio received from trainees. The speech-to-text then runs the network audio channels, in parallel groups of 1028 bytes, through a speech-to-text language library built from open-source large language models (“LLM”). The speech-to-text conversion provides the system with the text translation of what the trainee(s) said. This text is then referenced against a large, weighted dictionary of spoken words to machine-readable commands. The output can then be used as a driving factor that triggers nearby character(s) to elicit a response or reaction. The output may also be used to automatically modify a character's compliance level.

The overall goal is to convert spoken words into actions the software can invoke that both alter compliance as well as trigger actions based on compliance.

The speech-to-text functionality may also be used to create “suggested actions” to the instructor. For example, speech-to-text may provide suggested actions to the instructor in cases where the instructor does not want complete automation, but still requires assistance. When a trainee talks, requesting the character to do something, the speech-to-text process results in two possible actions; a compliant and a non-compliant one. Then the compliance level of the selected character is taken into account and the system decides which one is shown to the instructor as a “suggestion”. Again, all driven by the single-value compliance level that can be altered dynamically.

### Voice Modulation

Another feature that may be influenced by a character's compliance level is instructor voice modulation. This feature enables an instructor to select a character then speak as that character. The instructor networked audio via voice comms is then “placed” in 3D space to give directional feedback to trainees at the point of the character. The character also begins moving the blend shapes on their face such as lips, jaw, tongue, and cheeks to “lip sync” to the incoming instructor audio. The instructor's voice coming from the character may be modulated by both changing the pitch and slightly altering the tempo. This alteration is done to give the voice a more feminine or masculine tone depending on the gender of the selected character.

Compliance influences this capability by changing the facial expression of the character when the instructor is talking. A lower compliance, meaning more aggressive, puts a frown or general “disgust” look on the character's face. A higher compliance, meaning more passive, gives a more neutral or even slightly scared look on the character's face. This expression persists during and through the character lip syncing—as an additive blend on top of the talking motions.

As may be appreciated, examples of how the single compliance value associated with each character can affect the actions and responses of the character are provided. One skilled in the art will appreciate these examples are not the only use of the single compliance value and numerous other responses may be influenced by the compliance value without departing from the scope of the teachings herein.

What is claimed is:

1. A system for controlling characters in a judgmental use of force training simulation comprising:
a compliance range having a first endpoint that corresponds to maximum compliance and an opposite endpoint that corresponds to maximum non-compliance and values between the first endpoint and opposite endpoint corresponding to varying levels of compliance between maximum compliance and maximum non-compliance;
a plurality of characters wherein each character in the plurality of characters is assigned a first single compliance value from the compliance range;
a plurality of pools of macros wherein each pool of macros in the plurality of pools corresponds to a particular character response and wherein each macro in any pool of macros from any plurality of pools of macros is assigned a second single compliance value from the compliance range; and
wherein the system is designed to select a macro with the closest second single compliance value to the first single compliance value when selecting an appropriate action response for a character from the plurality of characters.

2. The system of claim 1, wherein the compliance range has a median that represents a neutral response and responses become progressively more non-compliant on one side of the median and progressively more compliant on an opposite side of the median.

3. The system of claim 1, wherein the first single compliance value is selectable prior to commencement of the simulation and adjustable thereafter.

4. The system of claim 1, further comprising a system wide compliance value that can control the first single compliance value for each character in the plurality of characters.

5. The system of claim 1, wherein the first single compliance value is designed to adjust automatically based on a response of a trainee.

6. The system of claim 1, wherein subsets of characters from the plurality of characters are grouped into teams and the first single compliance value of each character in a team is designed to be set by a single team compliance value.

7. The system of claim 1, wherein each macro, from a pool of macros from the plurality of pools of macros is comprised of a plurality of character actions.

8. The system of claim 7, wherein each character action is assigned a third compliance value from the compliance range.

9. The system of claim 8, wherein the second compliance value for each macro is comprised from the third compliance value of each character action in each macro.

10. The system of claim 1, wherein each character's facial expression is adjusted based on the first compliance value.

11. A method for controlling characters in a judgmental use of force training simulation comprising:
assigning a first compliance value to each character in the simulation wherein the first compliance value is selected from a compliance range having a first endpoint that corresponds to maximum compliance and an opposite endpoint that corresponds to maximum non-compliance and values between the first endpoint and opposite endpoint corresponding to varying levels of compliance between maximum compliance and maximum non-compliance;
receiving a request for an action for a first character in the simulation;
selecting a pool of macros that corresponds with an appropriate response to the request for an action;
selecting a macro from the pool of macros wherein each macro in the pool of macros is assigned a second single compliance value from the compliance range and the selecting step selects a macro with the closest second single compliance value to the first single compliance value; and
executing the macro to cause the first character to respond to the request for action.

12. The method of claim 11, wherein the compliance range has a median that represents a neutral response and responses become progressively more non-compliant on one side of the median and progressively more compliant on an opposite side of the median.

13. The method of claim 11, further comprising the step of setting the first single compliance value prior to commencement of the simulation.

14. The method of claim 11, further comprising the step of adjusting the first single compliance value during the simulation.

15. The method of claim 11, further comprising the step of adjusting the first single compliance value based on a response of a trainee.

16. The method of claim 11, further comprising grouping a subset of characters from the plurality of characters into teams and setting the first single compliance value of each character in a team by setting a single team compliance value.

17. The method of claim 11, wherein each macro, from a pool of macros from the plurality of pools of macros is comprised of a plurality of character actions.

18. The method of claim 17, wherein each character action is assigned a third compliance value from the compliance range.

19. The method of claim 18, wherein the second compliance value for each macro is comprised from the third compliance value of each character action in each macro.

20. The method of claim 11, wherein each character's facial expression is adjusted based on the first compliance value.
